(19) United States
(12) Patent Application Publication
(10) Pub. No.: US 2026/0186909 A1
(43) Pub. Date: Jul. 2, 2026

(54) SYSTEM AND METHOD FOR REDUCING REDUNDANT READS IN DUAL SCANNING WITHIN A DEDUPLICATED ENVIRONMENT

(71) Applicant: Eon IO, Ltd., Tel Aviv (IL)

(72) Inventors: Assaf NATANZON, Tel Aviv (IL); Dmitry KUZNETSOV, Tel Aviv Yafo (IL); Haim BEN-SHIMOL, Kfar Saba (IL); Ron KIMCHI, Tel Aviv (IL)

(73) Assignee: Eon IO, Ltd., Tel Aviv (IL)

(21) Appl. No.: 19/186,150

(22) Filed: Apr. 22, 2025

Related U.S. Application Data
(63) Continuation-in-part of application No. 19/002,274, filed on Dec. 26, 2024.

(51) Int. Cl. G06F 11/14

(52) U.S. Cl. CPC G06F 11/1453; G06F 2201/80

(57) ABSTRACT

A method and system for generating a backup using file-level scanning and block-level scanning is presented. The method includes obtaining a snapshot of a storage volume associated with a virtualization environment; reading a filesystem on the snapshot to identify one or more files; generating a file-level backup of data corresponding to each of the identified files; retrieving one or more block-level addresses corresponding to the file-level data; determining which data blocks were read during the file-level backup based on the one or more block-level addresses; and generating a block-level backup by reading data blocks that were not read during the file-level backup.

### CROSS-REFERENCE TO RELATED APPLICATION(S)

This application is a continuation-in-part of U.S. Non-Provisional application Ser. No. 19/002,274, filed on Dec. 26, 2024, now pending, the content of which is hereby incorporated by reference.

### TECHNICAL FIELD

The present disclosure relates generally to backup and restoration of files, and specifically to systems and methods for reducing redundant reads in dual scanning for both file-level and block-level backups within a deduplicated environment.

### BACKGROUND

File-level and block-level backups are two common strategies for safeguarding data. File-level backups concentrate on copying individual files and their metadata, offering simplicity and quick file-specific restores. However, they can be slower for large datasets and often do not capture system-wide states effectively. Conversely, block-level backups operate on low-level storage blocks, making them efficient for large datasets or minimal data changes, and well-suited for full-system restorations. Yet, block-level solutions lack file-level granularity, making it less straightforward to restore individual files.

One approach combines file-level and block-level scanning to address many challenges of conventional solutions. By performing both types of backup, that approach addresses many challenges of conventional solutions and enables flexible restore capabilities, from individual files to entire systems.

While combining file-level and block-level scans significantly enhances restore functionality, certain scenarios may still involve re-reading the same blocks even though those blocks were already accessed during the file-level pass. Particularly in highly fragmented file systems or large datasets, this repetition can lead to increased I/O, making backups more time-consuming and resource intensive. Moreover, deduplication processes can further exacerbate these inefficiencies if blocks are scanned multiple times or contain partially overlapping data.

It would therefore be advantageous to refine existing dual-scanning techniques in a way that preserves file-level granularity and comprehensive block-level coverage, while reducing redundant reads, thereby minimizing repeated scanning in deduplicated environments.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include obtaining a snapshot of a storage volume associated with a virtualization environment. The method may also include reading a filesystem on the snapshot to identify one or more files. The method may furthermore include generating a file-level backup of data corresponding to each of the identified files. The method may in addition include retrieving one or more block-level addresses corresponding to the file-level data. The method may moreover include determining which data blocks were read during the file-level backup based on the one or more block-level addresses. The method may also include generating a block-level backup by reading data blocks that were not read during the file-level backup. Other embodiments of this aspect include corresponding computer systems, apparatus, and computer programs recorded on one or more computer storage devices, each configured to perform the actions of the methods.

Implementations may include one or more of the following features. The method where generating the file-level backup further may include: reading data from each of the identified files in data chunks; hashing the data chunks; and comparing each of the data chunks to an existing deduplication index. The method where data blocks utilized by each file are flagged as previously read except for an utilized last data block. The method where generating the block-level backup further may include: reading only data blocks that were not flagged as previously read during the generation of the file-level backup. The method may include: merging metadata from the file-level backup and the block-level backup into an unified record that references data blocks in the storage volume. The method may include: using the unified record to restore the one or more identified files corresponding to the file-level backup. The method where obtaining a snapshot further may include: requesting a point-in-time snapshot of the storage volume via a hypervisor or virtualization API. The method where reading the filesystem on the snapshot further may include: mounting the snapshot as a read-only volume and enumerating directories to locate each file. The method may include: flagging one or more partially used data blocks during the file-level backup if one or more data blocks are partially occupied by a file; and re-examining the one or more partially used blocks during the block-level backup. The method may include: storing a mapping of each block in the snapshot volume to either the file-level backup or the block-level backup. The method may include: generating a block-level manifest that associates each logical block address of the snapshot volume with a storage reference in a backup repository, where the block-level manifest enables restoration of the snapshot volume; and generating a file-level manifest that associates an identifier for each of the identified files with at least one storage reference, where the file-level manifest enables restoration of the identified files without requiring restoration of the snapshot volume. Implementations of the described techniques may include hardware, a method or process, or a computer tangible medium.

In one general aspect, a non-transitory computer-readable medium may include one or more instructions that, when executed by one or more processors of a device, cause the device to: obtain a snapshot of a storage volume associated with a virtualization environment. Medium may furthermore read a filesystem on the snapshot to identify one or more files. Medium may in addition generate a file-level backup of data corresponding to each of the identified files. Medium may moreover retrieve one or more block-level addresses corresponding to the file-level data. Medium may also determine which data blocks were read during the file-level backup based on the one or more block-level addresses. Medium may furthermore generate a block-level backup by reading data blocks that were not read during the file-level backup. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: obtain a snapshot of a storage volume associated with a virtualization environment. The system may in addition read a filesystem on the snapshot to identify one or more files. The system may moreover generate a file-level backup of data corresponding to each of the identified files. The system may also retrieve one or more block-level addresses corresponding to the file-level data. The system may furthermore determine which data blocks were read during the file-level backup based on the one or more block-level addresses. The system may in addition generate a block-level backup by reading data blocks that were not read during the file-level backup. Other embodiments of this aspect include corresponding computer systems, apparatus, and computer programs recorded on one or more computer storage devices, each configured to perform the actions of the methods.

Implementations may include one or more of the following features. The system where the memory contains further instructions that, when executed by the processing circuitry for generating the file-level backup, further configure the system to: read data from each of the identified files in data chunks; hash the data chunks; and compare each of the data chunks to an existing deduplication index. The system where data blocks utilized by each file are flagged as previously read except for an utilized last data block. The system where the memory contains further instructions that, when executed by the processing circuitry for generating the block-level backup, further configure the system to: read only data blocks that were not flagged as previously read during the generation of the file-level backup. The system where the memory contains further instructions which when executed by the processing circuitry further configure the system to: merge metadata from the file-level backup and the block-level backup into an unified record that references data blocks in the storage volume. The system where the memory contains further instructions which when executed by the processing circuitry further configure the system to: use the unified record to restore the one or more identified files corresponding to the file-level backup. The system where the memory contains further instructions that, when executed by the processing circuitry for obtaining a snapshot, further configure the system to: request a point-in-time snapshot of the storage volume via a hypervisor or virtualization API. The system where the memory contains further instructions that, when executed by the processing circuitry for reading the filesystem on the snapshot, further configure the system to: mount the snapshot as a read-only volume and enumerating directories to locate each file. The system where the memory contains further instructions which when executed by the processing circuitry further configure the system to: flag one or more partially used data blocks during the file-level backup if one or more data blocks are partially occupied by a file; and re-examine the one or more partially used blocks during the block-level backup. The system where the memory contains further instructions which when executed by the processing circuitry further configure the system to: store a mapping of each block in the snapshot volume to either the file-level backup or the block-level backup. The system where the memory contains further instructions which when executed by the processing circuitry further configure the system to: generate a block-level manifest that associates each logical block address of the snapshot volume with a storage reference in a backup repository, where the block-level manifest enables restoration of the snapshot volume; and generate a file-level manifest that associates an identifier for each of the identified files with at least one storage reference, where the file-level manifest enables restoration of the identified files without requiring restoration of the snapshot volume. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

In the drawings:

FIG. 1 is an example schematic diagram of a virtualization including a block-level storage for backup generation, implemented in accordance with an embodiment.

FIG. 2 is an example schematic illustration of a file-level backup utilizing block-level deduplication, implemented in accordance with an embodiment.

FIG. 3 is an example flowchart of a method for performing file-level backup utilizing block-level deduplication, implemented according to an embodiment.

FIG. 4 is an example flowchart of a dual scanning backup method including file-level and block-level processing, implemented in accordance with an embodiment.

FIG. 5 is an example flowchart of a file-level scanning method for identifying and flagging data blocks, implemented in accordance with an embodiment.

FIG. 6 is an example flowchart of a block-level scanning method for processing data blocks not previously flagged by a file-level scan, implemented in accordance with an embodiment.

FIG. 7 is an example flowchart of a method for merging metadata from the file-level and block-level backups, implemented in accordance with an embodiment.

FIG. 8 is an example schematic diagram of a backup generator, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

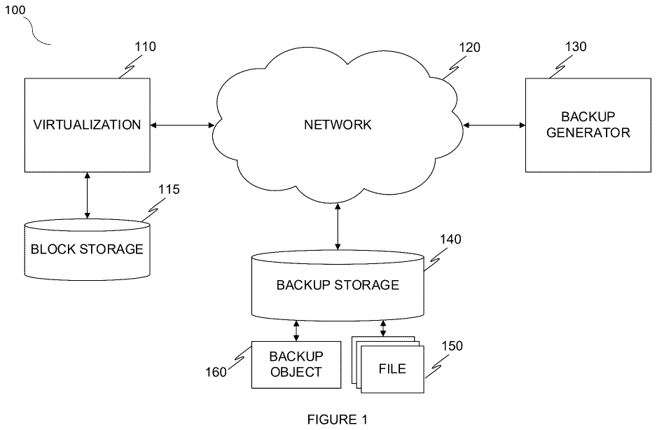

FIG. 1 is an example schematic diagram 100 of a virtualization including a block-level storage for backup generation, implemented in accordance with an embodiment. In an embodiment, a virtualization 110 is a virtual machine, software container, and the like. In some embodiments, the virtualization 110 is associated with a block storage device 115. The backup is of the block storage device 115.

According to an embodiment, the block storage device 115 is configured to store data in fixed-sized blocks, each with a unique address, allowing efficient access and management. Unlike file storage, block storage does not organize data hierarchically, instead leaving structure handling to the operating system, applications, and the like. It is ideal for databases, virtual machines, and high-performance applications. An example is an Amazon® Elastic Block Store (EBS) volume, which provides scalable, block-level storage for use with Amazon Elastic Container Service (EC2) instances.

In an embodiment, the virtualization 110 is deployed in a computing environment that includes a network 120. In some embodiments, the network 120 provides connectivity for the computing environment, utilizing various network interfaces, network protocols, etc.

In some embodiments, the computing environment is an on-prem environment, a hybrid environment, a cloud computing environment, a combination thereof, and the like. A computing environment includes, for example, a virtual private cloud, a virtual network, a virtual private network, a combination thereof, and the like.

According to an embodiment, the cloud computing environment is deployed on a cloud computing infrastructure, such as Amazon® Web Service (AWS), Google® Cloud Platform (GCP), Microsoft® Azure, and the like. In an embodiment, the network further provides connectivity to a backup storage 140 and a backup generator 130. In an embodiment, the backup generator 130 is a computer server implemented, for example, as a virtual machine, a software container, a serverless function, a combination thereof, and the like.

In an embodiment, the backup generator 130 is configured to access the block storage 115 of the virtualization 110, and generate a backup therefrom. In some embodiments, a backup is generated periodically. In certain embodiments, a plurality of periodic backups are generated, each corresponding to a restoration point.

In some embodiments, the backup generator 130 is configured to access a filesystem of the block storage 115. According to an embodiment, a filesystem is a system used by an operating system to organize, store, and retrieve data on storage devices. It manages data as files and directories, keeping track of their locations, sizes, and metadata. Filesystems ensure efficient storage allocation, provide access permissions, and maintain data integrity. Examples include NTFS, ext4, and APFS.

According to certain embodiments, the backup generator 130 is configured to read files from the block storage 115 and generate a plurality of files 150 as a backup in a backup storage 140. In some embodiments, the plurality of files is stored as objects in the backup storage 140, such as backup object 160.

For example, a backup storage 140 is implemented, in an embodiment, as Amazon® Simple Storage Service (S3). In an embodiment, the backup generator 130 is configured to generate a manifest for each file to indicate where data blocks of the file are stored (e.g., what backup objects a particular file is stored in). According to an embodiment, the virtualization 110, the backup generator 130, the backup storage 140, a combination thereof, and the like, are deployed in a cloud computing environment.

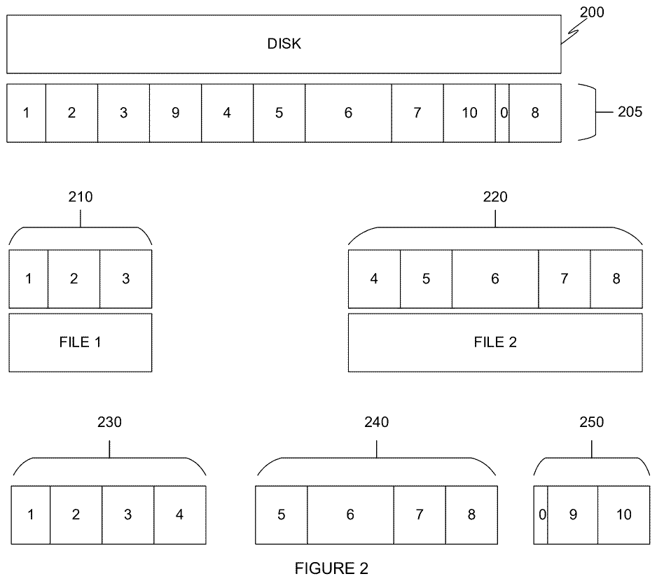

In an embodiment, data blocks of the same file are stored in proximity to each other (e.g., in the same backup object, in backup objects that have proximate addresses, etc.) to minimize the number of objects a file is stored on, which in turn allows for restoration of single files utilizing a minimal amount of compute resources and minimizing the access to different objects. This is explained in more detail with respect to FIG. 2 below.

In some embodiments, a backup (e.g., a restoration point) includes a file-level backup and a block-level backup. In certain embodiments, a file-level backup is initiated first, and once complete, a block-level backup is generated, which is deduplicated based on the file-level backup. This benefits from the advantages of both the file-level backup scheme and the block-level backup scheme.

FIG. 2 is an example schematic illustration of a file-level backup utilizing block-level deduplication, implemented in accordance with an embodiment. In an embodiment, a disk 200 includes a plurality of files. The disk 200 is a block-level storage device and includes a plurality of data blocks 205. In this example, the data blocks are variable-sized and numbered 0 through 10, though in a fragmented order.

In an embodiment, the disk 200 includes a first file 210, which is stored on blocks 1 through 3, and a second file 220 is stored on blocks 4 through 8. By configuring a backup generator to read the filesystem and detect the files, the backup objects 230 through 250 are generated such that they correspond to the file structure.

For example, a first backup object 230 includes blocks 1 through 4, a second backup object 240 includes blocks 5 through 8, and a third backup object 250 includes blocks 0, 9, and 10. In order to restore the first file 230, a manifest associated with the first file is read, and this allows determining that the first backup object 230 is required for restoring the first file 230. It should be noted that several files can be backed up to the same object, and the manifest will point to different locations within the object. Further, a large file may span multiple objects in the backup.

In order to restore the second file 220, it is sufficient to read the first data object 230 and the second data object 240, and there is no need to read the third data object 250, unless a full system restore is required. It should be noted that if a full system restore is required, the data is readily available. Thus, the benefit of both file-level backup and block-level backup is realized when restoring single files or restoring the entire system to an earlier state.

In one embodiment, a snapshot of the virtualization is taken before backing it up. The disks attached to a backup generator are then used to store the backup.

It is important to note that the file system may occupy part of a volume (i.e., a partitioned volume) or span multiple volumes (using a volume manager). In the disclosed embodiments, regardless of the configuration, the file systems on the volume are backed up, and then the entire volume or volumes are backed up. Typically, backup systems create a backup of both the device and the block device. Afterward, these systems generate a list of the files backed up from the block device. During the restoration process, the block device is mounted, and the files are then extracted.

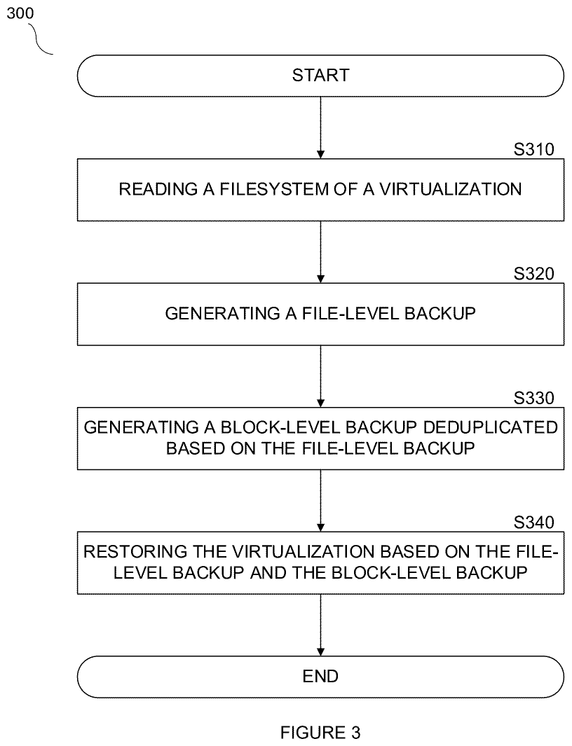

FIG. 3 is a flowchart 300 of a method for performing file-level backup utilizing block-level deduplication, implemented according to an embodiment. In an embodiment, performing file-level backup utilizing block-level deduplication allows for the benefit of the ability to restore single files in an efficient and computationally low-overhead manner, while also providing the speed and accuracy of block-level restoration.

At S310, a filesystem is read. In an embodiment, the filesystem is a block-level storage device of a virtualization deployed in a cloud computing environment. A filesystem is a system that organizes, stores, and manages data on storage devices like hard drives or SSDs. It defines how files are named, stored, retrieved, and accessed, using structures like directories, files, and metadata. Filesystems also handle file permissions, security, and data integrity. Examples include NTFS, ext4, and APFS.

In an embodiment, the filesystem is read to detect a plurality of files and their locations (i.e., block addresses) in a block-level storage device. In some embodiments, a backup generator is provided with credentials to access a block-level storage device in a cloud computing environment.

At S320, a file-level backup is generated. In an embodiment, the file-level backup is generated for a first time. In some embodiments, the file-level backup includes generating a plurality of backup objects, such as storage blobs. In some embodiments, the backup objects are stored in a cloud storage, such as AWS S3.

In an embodiment, the file-level backup includes generating a backup object which includes therein a plurality of data blocks, at least a portion of which are associated with a first file. In some embodiments, the file-level backup includes a manifest that is generated for each file for a plurality of files, etc. It should be noted that the manifests are stored in objects, for example, in S3. Each such object contains the manifests of multiple files (rather than one object per file). In some embodiments, the manifest includes a location, a pointer, an address, a mapping, and the like, for locating a data block associated with a file. According to an embodiment, each data block which is associated with a file of the filesystem is stored in a backup object of a plurality of backup objects.

At S330, a block-level backup is generated. In an embodiment, the block-level backup is generated utilizing deduplication, which is based on the file-level backup. For example, according to an embodiment, a data block which is stored in a backup object when generating the file-level backup, is not stored in the block-level backup.

In certain embodiments, the block-level backup allows restoring a system including each and every data block, while storing certain data blocks in locations that utilize file-level backup efficiency when restoring single files.

In an embodiment, the block-level backup includes fixed-size blocks, variable-size blocks, or any other suitable block format. In some embodiments, for example, where a fixed-size block is selected, the block size is selected to be a divisor of a block size of the file system. For example, where the block size of the filesystem is 8 kb, a block size of the block-level backup is 8 kb, 4 kb, etc.

At S340, restoration is initiated. In an embodiment, a restoration request includes a restoration of the entire system (i.e., block-level restoration), single file restoration, a combination thereof, and the like.

In some embodiments, where a single file is selected for restoration, multiple single files are selected for restoration, etc., a manifest of the file is accessed to determine which backup objects should be read.

In an embodiment, in a file-level restoration, the backup objects are read, and the relevant data blocks are extracted from the backup object, allowing the file to be restored from the relevant data blocks. In some embodiments, a restoration request includes a full system restoration, which includes restoring a block device. In an embodiment, this includes reading backup objects of the block-level backup and backup objects of file-level backup objects to extract from each data block, and initiating a full block device restoration from all the extracted data blocks.

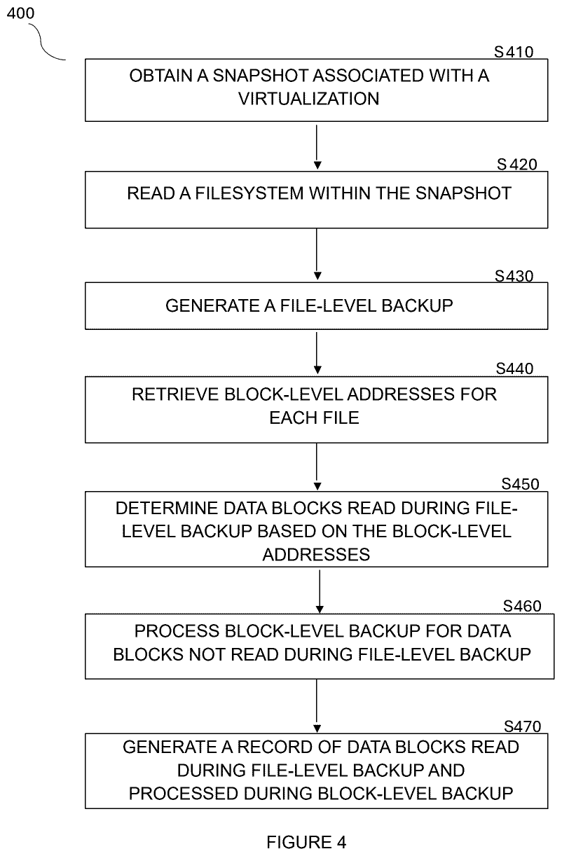

FIG. 4 is an example flowchart 400 of a dual scanning backup method including file-level and block-level processing, implemented in accordance with an embodiment.

At step 410, a snapshot associated with a virtualization is obtained. In some embodiments, a point-in-time snapshot of one or more volumes or block devices used within a virtualization environment may be obtained. The virtualization may be a virtual machine, container, or another type of software-based resource running on a hypervisor or cloud platform. Obtaining the snapshot allows subsequent read operations, whether file-level or block-level, to be performed against a consistent, unchanging data set. This snapshot may be initiated by a hypervisor Application Programming Interface (API), a volume manager, or a cloud storage service's snapshot mechanism.

At S420, a filesystem within the snapshot is read. Once the snapshot has been generated, the snapshot may be attached or otherwise made accessible in a read-only mode to a backup environment, such as a backup generator or backup host. In some embodiments, the filesystem may then be mounted to facilitate traversal of directories, retrieval of file metadata (such as size and modification timestamps), and subsequent reading of file contents. Accessing the snapshot may require specifying the filesystem type (e.g., ext4, NTFS, XFS, etc.) along with relevant parameters (e.g., block size), thereby ensuring that all files on the snapshot volume can be enumerated and accessed reliably.

At S430, a file-level backup is generated. For example, each file within the snapshot's filesystem is read and divided into multiple deduplication chunks (e.g., fixed-size or variable-size, such as using a rolling hash to determine chunk boundaries). Each chunk may be hashed and compared with a deduplication index, which may reside locally or on a remote backup repository. If an identical chunk is already present in the backup repository, a reference to that chunk is used to avoid duplication; otherwise, the new chunk is uploaded or recorded. By the end of this step, a file-level backup is formed, which may include a record (such as a manifest) that indicates which chunks belong to each file. This file-level backup process supports efficient single-file restores.

At S440, block-level addresses for each file are retrieved. After the file-level backup is generated, each file's logical extents may be mapped to the corresponding physical block addresses on the snapshot volume. In some embodiments, the data structure (bitmap or table) is updated during or immediately after the file-level pass. This mapping can then be retrieved to determine the specific blocks that were already captured during the file-level scan. In some embodiments, a filesystem utility (e.g., filefrag) or filesystem API is employed to obtain these block-level offsets for each file. The offsets may be stored in a data structure, such as a bitmap or a table, indicating which blocks were already captured by the file-level scan. This mapping can be referenced to identify blocks that require re-reading in subsequent steps.

At 450, data blocks read during file-level backup are determined based on the block-level addresses. In some embodiments, physical blocks that have already been read and deduplicated in the file-level process can be identified using the retrieved addresses. In some embodiments, if a block is fully consumed by a file, that block may be marked as “already processed.” If a block includes space beyond the file's last byte, that leftover region may contain previously deleted data or content from other files, so that block may be flagged for re-evaluation. In addition, the identified addresses may be sorted in ascending order to help determine which blocks remain unprocessed. Accordingly, only blocks that potentially contain data outside the file-level scan are processed further, while fully accounted-for blocks are skipped.

At S460, a block-level backup is processed for data blocks not read during the file-level backup. In some embodiments, a block-level pass is performed over the snapshot volume (e.g., in ascending block order), referencing previously generated indicators of “already processed” blocks. Blocks identified as fully read at the file level are skipped. Only the remaining blocks (including partially used blocks) are read to ensure that any data not covered by the file-level pass is deduplicated. Once retrieved, the data in these blocks may be deduplicated against any existing index, and any resulting chunks are stored or referenced accordingly. Accordingly, any regions not captured by the file-level pass are included in the final backup.

At S470, a record of data blocks read during the file-level backup and processed during the block-level backup is generated. In some embodiments, this record includes or finalizes a block-level manifest referencing each block in the snapshot volume. The record may specify which blocks were accounted for by the file-level backup and which blocks were newly read in the block-level pass. By combining the file-level and block-level records, either an individual file or an entire volume can be restored. In some embodiments, additional post-processing steps (such as encryption, compression, or replication) may be applied to the resulting manifest and data objects. Once this record is prepared, the process concludes, yielding a comprehensive, deduplicated backup suitable for various restore scenarios.

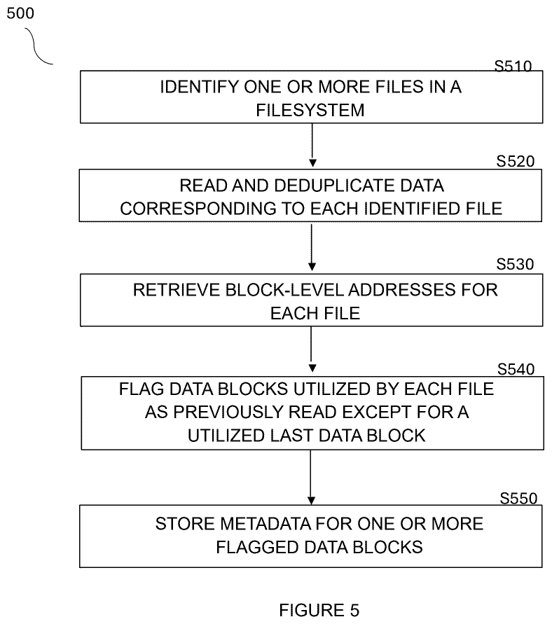

FIG. 5 is an example flowchart 500 of a file-level scanning method for identifying and flagging data blocks, implemented in accordance with an embodiment.

At S510, one or more files in a filesystem are identified. In some embodiments, files residing on the snapshot volume are identified by enumerating directory structures and reading file metadata such as filenames, sizes, and modification timestamps. This metadata may also include other relevant attributes (e.g., permissions or extended attributes). By selecting the files to be processed for backup in this manner, the backup operation captures a consistent snapshot of the file system.

At S520, data corresponding to each identified file is read and deduplicated. In some embodiments, each file's content may be read in segments referred to as chunks. A chunk may represent a contiguous portion of file data that is processed as a single unit for deduplication. These chunks may be of fixed size (e.g., 4 KB or 8 KB), where the file is broken into uniform segments until the end of the file is reached, or variable size determined by content-defined boundaries, where a rolling hash or similar technique determines chunk boundaries based on the file's content. For example, if the chunk size is set to 8 KB and the file is 20 KB, two full 8 KB chunks are created, and a final 4 KB chunk holds the remainder. After each chunk is formed, it can be hashed and compared to an existing deduplication index. If an identical chunk is already stored, a reference is used rather than creating a new copy; otherwise, the new chunk is recorded. This chunk-based approach reduces redundant data storage when multiple files or multiple backup versions contain the same data segments.

At S530, block-level addresses for each file are retrieved. In some embodiments, following or during the chunking process, a utility or filesystem function may be employed to determine the physical block addresses where each file resides. These addresses can be stored in a structure such as a bitmap or a table, indicating that data in those blocks has already been read at the file level. By capturing these addresses, subsequent block-level processing can skip over blocks that have been accounted for through the file-level pass, thereby avoiding redundant reads.

At S540, data blocks utilized by each file are flagged as previously read except for a utilized last data block. For example, if a chunk fully occupies a data block, that block can be marked as already read, preventing redundant scanning in later steps. In some embodiments, a final chunk (the last portion of file data) may be smaller than preceding chunks if the file's length does not align exactly with a block boundary. For example, a block boundary may correspond to a fixed-size allocation unit used by the filesystem such as 4 KB. If the final chunk occupies only part of that data block, any leftover space may lie beyond the file's actual data range. Since that leftover region could contain data from another file or from deleted content, the partially filled block containing the final chunk (referred to as the last block) can be flagged for further evaluation in a subsequent backup phase. This additional evaluation ensures that unused portions of the block are not inadvertently excluded from the overall backup. By contrast, blocks that are fully occupied by the file can be designated as already processed, minimizing redundant reads of data.

At S550, metadata for one or more flagged data blocks is stored. Once blocks have been flagged or marked, metadata reflecting these designations may be recorded. This metadata may indicate which blocks were fully processed by the file-level pass and which last-block offsets remain subject to additional checks. In some embodiments, the metadata can also include references to each chunk's unique identifier or stored object address, allowing a future restore operation to locate the correct segments quickly. By maintaining structured records of block usage, this scanning process S500 facilitates efficient transitions to subsequent stages in the backup flow, ensuring that deduplication coverage remains accurate and complete.

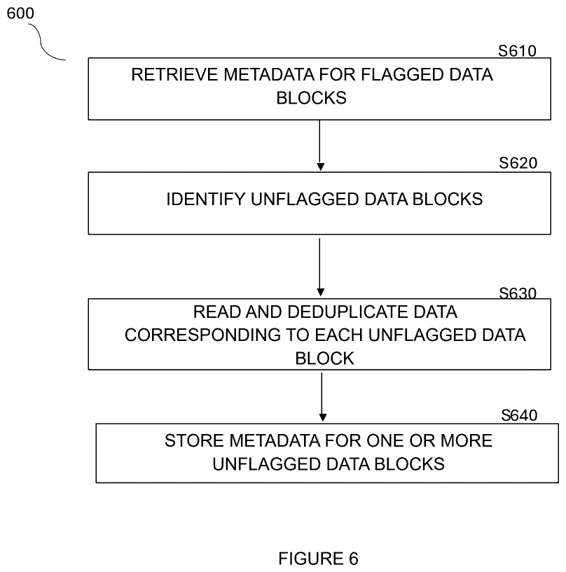

FIG. 6 is an example flowchart of a block-level scanning method for processing data blocks not previously flagged by a file-level scan, implemented in accordance with an embodiment.

At S610, metadata for flagged data blocks is retrieved. In some embodiments, a previous file-level scanning process flags certain blocks as requiring further scrutiny, for example, a partially utilized block that may contain data beyond a file's last byte. These flags may be stored in a bitmap, table, or manifest. Retrieving the metadata may involve examining each flagged block's entry to confirm why it was flagged (e.g., leftover space or uncertain data).

At S620, unflagged data blocks are identified. In some embodiments, any blocks not marked by the file-level process (i.e., unflagged) may be identified. By identifying these unflagged blocks, the backup procedure ensures that all data segments not explicitly confirmed at the file level are recognized for potential reading and deduplication.

At S630, read and deduplicate data in unflagged blocks. Once the unflagged blocks have been determined, data from each of the unflagged blocks may be read from the snapshot volume. In some examples, a deduplication algorithm is applied (such as chunk-based hashing), allowing the backup to store only references for any chunks already present in a deduplication index. New or unique chunks may be recorded in a backup repository. This process allows any segments not captured at the file level, including unallocated space that still contains relevant data, to be incorporated into the final backup.

At S640, store updated metadata for processed blocks. Upon completing the deduplication of unflagged blocks, updated metadata may be recorded in a suitable data structure. This metadata may reflect whether each block is now fully processed or whether any further actions are required. In some embodiments, references to chunk identifiers or object offsets are included, providing a clear mapping from block addresses to stored backup data.

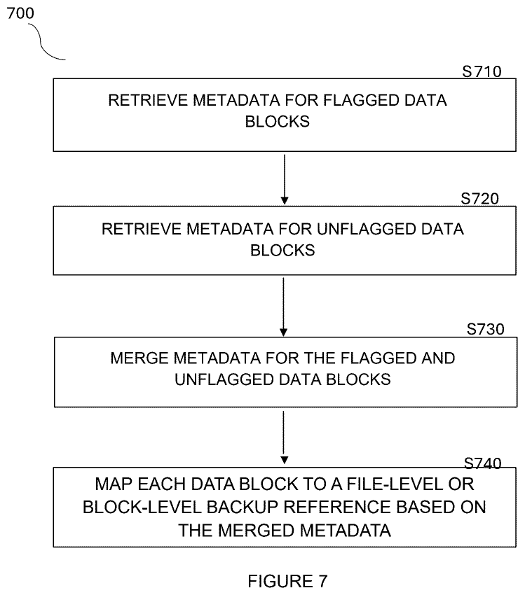

FIG. 7 is an example flowchart 700 of a method for merging metadata from the file-level and block-level backups, implemented in accordance with an embodiment.

At S710, retrieve metadata for flagged data blocks. In some embodiments, flagged data blocks represent those data blocks that were partially covered or otherwise marked for further evaluation during previous backup steps. For example, a partially utilized last block may have been flagged if leftover space extended beyond the file's final byte. Retrieving metadata for these flagged blocks may involve accessing a bitmap, table, or manifest that associates each flagged block with a reason or condition requiring additional evaluation (such as uncertain leftover space).

At S720, retrieve metadata for unflagged data blocks. In some embodiments, once flagged blocks are gathered, unflagged blocks are retrieved. These may include blocks that were deemed fully consumed at the file-level pass or blocks that were never flagged during a file level or block level pass. In some embodiments, unflagged blocks might also include blocks that align exactly with file boundaries, leaving no leftover space to trigger a flag.

At S730, merge metadata for the flagged and unflagged data blocks. Following retrieval of both sets of metadata, a merging operation may be performed to unify the references and statuses of each block. In some embodiments, the merging process aligns flagged entries (e.g., partially used blocks or uncertain leftover data) with unflagged entries (e.g., fully utilized blocks) to create a single repository or manifest that covers all blocks within a snapshot volume. During this merging step, any redundancies or overlaps may be resolved, for example, if the same block was flagged under multiple conditions or if new information clarifies a previously flagged block. The merging process results in a coherent view of how each block is represented in a final backup.

At S740, map each data block to a file-level or block-level backup reference based on the merged metadata. In some embodiments, this mapping involves associating each block with the appropriate reference, either from the file-level pass (e.g., a deduplicated chunk generated while scanning files) or from the block-level pass (e.g., a chunk captured when processing previously unflagged or partially used blocks). By applying the merged metadata in this manner, duplicate and overlapping references are resolved, thereby minimizing redundancy between the file-level and block-level records. In some embodiments, these references may be stored in a consolidated manifest or table, forming a unified resource for restoring any portion of the backup. This consolidated structure supports both single-file and entire-volume recoveries, ensuring that all data whether fully occupied by a file or flagged for additional verification remains accessible and accurately mapped to its deduplicated storage location.

In some embodiments, the merged metadata includes a block level manifest and a file level manifest that each reference a common set of deduplicated data objects. The block level manifest may be an address ordered list or index that associates each logical block address of the snapshot volume with a corresponding storage reference in a backup repository. The file level manifest may be an index in which a file identifier (e.g. an inode number, full path, or application-level handle) is associated with one or more storage references that collectively represent the data blocks storing the content of the file.

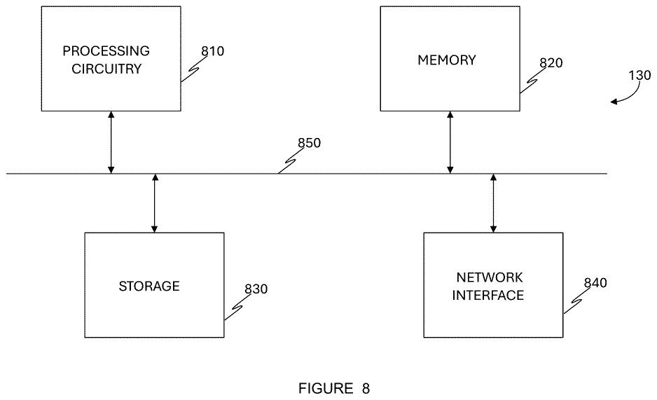

During a file level restore operation, the file level manifest may be evaluated independently of the block level manifest. The corresponding storage references are retrieved from the backup repository and the requested file is reconstructed without requiring restoration of the snapshot volume. Moreover, during a volume level restore operation, the block level manifest can be traversed (sequentially or in any order that optimizes I/O) to retrieve each storage reference from the backup repository and write the associated data blocks to a target device. FIG. 8 is an example schematic diagram of a backup generator, implemented in accordance with an embodiment. The backup generator 130 includes, according to an embodiment, a processing circuitry 810 coupled to a memory 820, a storage 830, and a network interface 840. In an embodiment, the components of the backup generator 130 are communicatively connected via a bus 850.

In certain embodiments, the processing circuitry 810 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 820 is a volatile memory (e.g., random access memory, etc.), a non-volatile memory (e.g., read-only memory, flash memory, etc.), a combination thereof, and the like. In some embodiments, the memory 820 is an on-chip memory, an off-chip memory, a combination thereof, and the like. In certain embodiments, the memory 820 is a scratch-pad memory for the processing circuitry 810.

In one configuration, software for implementing one or more embodiments disclosed herein is stored in the storage 830, in the memory 820, in a combination thereof, and/or on a separate repository accessible via the network interface 840. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 810, cause the processing circuitry 810 to perform the various processes described herein, including file-level scanning, block-level scanning, tracking, and skipping already-read blocks for deduplication, and the generation of a record or manifest for restoring both single files and entire volumes. In some embodiments, the memory 820 or storage 830 also maintains a data structure (e.g., a bitmap or table) that tracks which blocks have been read at the file level, thereby allowing the backup generator 130 to skip re-reading those same blocks during the block-level pass, consistent with the approaches described herein.

In some embodiments, the storage 830 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 840 is configured to provide the backup generator 130 with communication with, for example, the network 120, the virtualization 110, the backup storage 140, and the like, according to an embodiment. In some implementations, the backup generator 130 transmits deduplicated chunks or references to the backup storage 140 and receives file-level or block-level metadata via the network interface 840, thereby implementing some of the processes disclosed herein.

It should be understood that the embodiments described herein are not limited to the specific architecture illustrated in FIG. 8, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a backup using file-level scanning and block-level scanning, the method comprising:
obtaining a snapshot of a storage volume associated with a virtualization environment;
reading a filesystem on the snapshot to identify one or more files;
generating a file-level backup of data corresponding to each of the identified files;
retrieving one or more block-level addresses corresponding to the file-level data;
determining which data blocks were read during the file-level backup based on the one or more block-level addresses; and
generating a block-level backup by reading data blocks that were not read during the file-level backup.

2. The method of claim 1, wherein generating the file-level backup further comprises:
reading data from each of the identified files in data chunks;
hashing the data chunks; and
comparing each of the data chunks to an existing deduplication index.

3. The method of claim 1, wherein data blocks utilized by each file are flagged as previously read except for a utilized last data block.

4. The method of claim 3, wherein generating the block-level backup further comprises:
reading only data blocks that were not flagged as previously read during the generation of the file-level backup.

5. The method of claim 1, further comprises:
merging metadata from the file-level backup and the block-level backup into a unified record that references data blocks in the storage volume.

6. The method of claim 5, further comprises: using the unified record to restore the one or more identified files corresponding to the file-level backup.

7. The method of claim 1, wherein obtaining a snapshot further comprises:
requesting a point-in-time snapshot of the storage volume via a hypervisor or virtualization API.

8. The method of claim 1, wherein reading the filesystem on the snapshot further comprises:
mounting the snapshot as a read-only volume and enumerating directories to locate each file.

9. The method of claim 1, further comprises:
flagging one or more partially used data blocks during the file-level backup if one or more data blocks are partially occupied by a file; and
re-examining the one or more partially used blocks during the block-level backup.

10. The method of claim 1, further comprises:
storing a mapping of each block in the snapshot volume to either the file-level backup or the block-level backup.

11. The method of claim 1, further comprises:
generating a block-level manifest that associates each logical block address of the snapshot volume with a storage reference in a backup repository, wherein the block-level manifest enables restoration of the snapshot volume; and
generating a file-level manifest that associates an identifier for each of the identified files with at least one storage reference, wherein the file-level manifest enables restoration of the identified files without requiring restoration of the snapshot volume.

12. A non-transitory computer-readable medium storing a set of instructions for generating a backup using file-level scanning and block-level scanning, the set of instructions comprising:
one or more instructions that, when executed by one or more processors of a device, cause the device to:
obtain a snapshot of a storage volume associated with a virtualization environment;
read a filesystem on the snapshot to identify one or more files;
generate a file-level backup of data corresponding to each of the identified files;
retrieve one or more block-level addresses corresponding to the file-level data;
determine which data blocks were read during the file-level backup based on the one or more block-level addresses; and
generate a block-level backup by reading data blocks that were not read during the file-level backup.

13. A system for generating a backup using file-level scanning and block-level scanning comprising:
a processing circuitry;
a memory, the memory containing instructions that, when executed by the processing circuitry, configure the system to:
obtain a snapshot of a storage volume associated with a virtualization environment;
read a filesystem on the snapshot to identify one or more files;
generate a file-level backup of data corresponding to each of the identified files;
retrieve one or more block-level addresses corresponding to the file-level data;
determine which data blocks were read during the file-level backup based on the one or more block-level addresses; and
generate a block-level backup by reading data blocks that were not read during the file-level backup.

14. The system of claim 13, wherein the memory contains further instructions that, when executed by the processing circuitry for generating the file-level backup, further configure the system to:
read data from each of the identified files in data chunks;
hash the data chunks; and
compare each of the data chunks to an existing deduplication index.

15. The system of claim 13, wherein data blocks utilized by each file are flagged as previously read except for a utilized last data block.

16. The system of claim 15, wherein the memory contains further instructions that, when executed by the processing circuitry for generating the block-level backup, further configure the system to:
read only data blocks that were not flagged as previously read during the generation of the file-level backup.

17. The system of claim 13, wherein the memory contains further instructions which when executed by the processing circuitry further configure the system to:
merge metadata from the file-level backup and the block-level backup into a unified record that references data blocks in the storage volume.

18. The system of claim 17, wherein the memory contains further instructions which when executed by the processing circuitry further configure the system to:
use the unified record to restore the one or more identified files corresponding to the file-level backup.

19. The system of claim 13, wherein the memory contains further instructions that, when executed by the processing circuitry for obtaining a snapshot, further configure the system to:
request a point-in-time snapshot of the storage volume via a hypervisor or virtualization API.

20. The system of claim 13, wherein the memory contains further instructions that, when executed by the processing circuitry for reading the filesystem on the snapshot, further configure the system to:
mount the snapshot as a read-only volume and enumerating directories to locate each file.

21. The system of claim 13, wherein the memory contains further instructions which when executed by the processing circuitry further configure the system to:
flag one or more partially used data blocks during the file-level backup if one or more data blocks are partially occupied by a file; and
re-examine the one or more partially used blocks during the block-level backup.

22. The system of claim 13, wherein the memory contains further instructions which when executed by the processing circuitry further configure the system to:
store a mapping of each block in the snapshot volume to either the file-level backup or the block-level backup.

23. The system of claim 13, wherein the memory contains further instructions which when executed by the processing circuitry further configure the system to:
generate a block-level manifest that associates each logical block address of the snapshot volume with a storage reference in a backup repository, wherein the block-level manifest enables restoration of the snapshot volume; and
generate a file-level manifest that associates an identifier for each of the identified files with at least one storage reference, wherein the file-level manifest enables restoration of the identified files without requiring restoration of the snapshot volume.
